(19) United States
(12) Patent Application Publication
(10) Pub. No.: US 2003/0012991 A1
(43) Pub. Date: Jan. 16, 2003

(54) Pressure regulator for a fuel cell system and method of making a pressure regulator

(75) Inventors: Rainer Muehlherr, Kirchheim (DE); Michael Wagner, Kirchheim (DE)

Correspondence Address: CROWELL & MORING LLP, INTELLECTUAL PROPERTY GROUP, P.O. BOX 14300, WASHINGTON, DC, 20044-4300, US

(73) Assignee: Ballard Power Systems AG.

(21) Appl. No.: 10/146,135

(22) Filed: May 16, 2002

(30) Foreign Application Priority Data
May 17, 2001 (DE) 101 23 923.8

(51) Int. Cl. H01M 8/04; F17D 3/00

(52) U.S. Cl. 429/25; 48/191

(57) ABSTRACT

A pressure regulator for a fuel cell unit includes a membrane that separates the pressure regulator into an anode-side region and a cathode-side region. The membrane is acted in the anode-side region by the pressure of the anode side of the fuel cell unit and in the cathode-side region by the pressure of the cathode side of the fuel cell unit. The pressure regulator further includes an actuator connected to the membrane, wherein the actuator sets a predetermined pressure on at least one of the anode and cathode sides.

This application claims the priority of German Patent Document No. 101 23 923.8, filed May 17, 2001, the disclosure of which is expressly incorporated by reference herein.

### BACKGROUND AND SUMMARY OF THE INVENTION

The invention relates to a pressure regulator for a fuel cell unit and a method of making a pressure regulator.

JP 60212967 A discloses a pressure regulator for a fuel cell system. The pressure regulator comprises a membrane, which separates the pressure regulator into an anode-side region and a cathode-side region. The anode-side region has an inlet and an outlet for a hydrogen-rich gas, the outlet being connected to the inlet of the anode side of a fuel cell unit. Accordingly, the cathode-side region of the pressure regulator has an inlet and an outlet for an oxygen-rich gas, the outlet being connected to the inlet of the cathode side of a fuel cell unit. The pressure regulator is used to compensate for pressure differences between the hydrogen-rich gas and the oxygen-rich gas.

The present invention is based on an object of providing a pressure regulator which can be of flexible design and can efficiently establish a predetermined differential pressure between the anode side and the cathode side of a fuel cell unit.

This object is achieved by a pressure regulator in accordance with the present invention.

A pressure regulator of the present invention has an actuator which can act on the inlet side and also on the outlet side of the fuel cell unit. Therefore, there are numerous possible ways of setting the differential pressure between the anode side and the cathode side of the fuel cell unit. Therefore, the pressure regulator can be adapted to the spatial conditions available due to its flexible design. Advantageously, the effect of the regulator is reinforced by the simultaneous incorporation of the inlet and outlet sides.

The features which are listed above and are yet to be explained below can be used not only in the combination which is given in each instance but also in other combinations or on their own, without departing from the scope of the invention.

Further advantages and configurations of the invention will emerge from the description.

The invention is described in more detail below with reference to FIG. 1.

Other objects, advantages and novel features of the present invention will become apparent from the following detailed description of the invention when considered in conjunction with the accompanying drawings.

### BRIEF DESCRIPTION OF THE DRAWINGS

FIG. 1 is an outline illustration of a preferred pressure regulator having an actuator which acts on the inlet and the outlet of the anode side and on the inlet and the outlet of the cathode side of the fuel cell unit.

### DETAILED DESCRIPTION FO THE DRAWINGS

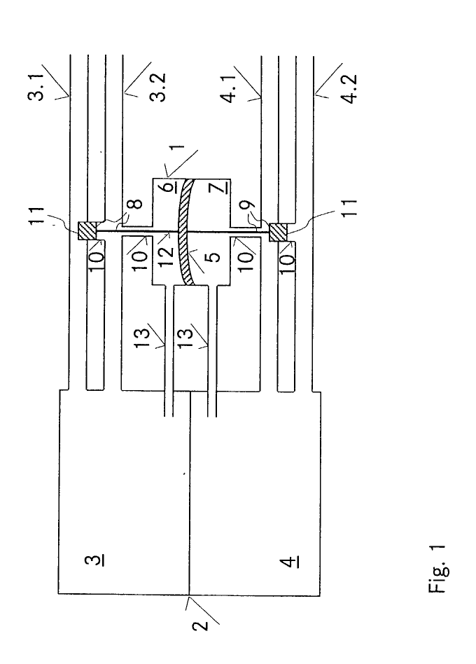

FIG. 1 shows an outline illustration of a preferred pressure regulator 1 for a fuel cell unit 2 having an anode side 3 and a cathode side 4. The anode side 3 of the fuel cell unit has an inlet 3.2 for hydrogen or a hydrogen-rich gas and an outlet 3.1 for anode exhaust gas. Correspondingly, the cathode side 4 of the fuel cell unit 2 has an inlet 4.1 for oxygen or an oxygen-rich gas and an outlet 4.2 for cathode exhaust gas. The pressure regulator 1 includes a membrane 5, which separates the pressure regulator 1 into an anode-side region 6 and a cathode-side region 7. In the anode-side region 6 of the pressure regulator 1, the membrane 5 is acted on by the pressure of the anode side 3 of the fuel cell unit 2. In the cathode-side region of the pressure regulator 1, the membrane 5 is acted on by the pressure of the cathode side 4 of the fuel cell unit 2. The pressure of the anode or cathode side 3, 4 is preferably applied to the membrane 5 via the lines 13, which connect the anode-side region 6 of the pressure regulator 1 to the anode side 3 and connect the cathode-side region 7 of the pressure regulator 1 to the cathode side 4 of the fuel cell unit.

The pressure regulator 1 can be used to set the same pressure on the anode side 3 and the cathode side 4 of the fuel cell unit 2. Furthermore, the pressure regulator 1 can be used to set a predetermined differential pressure between the anode side 3 and the cathode side 4. To set the pressure, the membrane 5 is connected to an actuator 8, 9. Furthermore, to set a predetermined differential pressure, a pre-stress may be applied to the membrane 5. The pre-stressing of the membrane 5 may be effected, for example, by means of a spring which is not shown and is assigned to the pressure regulator 1. Accordingly, the pressure regulation takes place purely mechanically and is far simpler than if an electronic control system with a control unit is used. The pressure regulator 1 is low-maintenance and inexpensive.

The actuator 8, 9 is rigidly connected to the membrane 5. If the membrane 5 is deformed as a result of a change in the pressure on the anode or cathode side 3, 4, the actuator follows the movement of the membrane. The actuator can therefore be moved to and fro by the movement of the membrane.

Moreover, the actuator 8, 9 comprises a blocking unit 11, which is rigidly connected to the membrane 5. This blocking unit 11 is advantageously connected to the membrane 5 via a rigid stem 12. The blocking unit 11 forms a gastight closure with the guide line 10 and is used to change the cross sections of the inlets 3.2, 4.1 and/or the outlets 3.1, 4.2 of the fuel cell unit 2.

The actuator 8, 9 acts simultaneously and in the same way on the cross section of the inlet 3.2 of the anode side 3 and on the cross section of the outlet 4.2 of the cathode side 4 or on the cross section of the outlet 3.1 of the anode side 3 and on the cross section of the inlet 4.1 of the cathode side 4. If the pressure on the anode side 3 is higher than the pressure on the cathode side 4, the membrane 5 expands into the region 7 and the actuator 8, 9 and/or the blocking unit 11 reduces the cross section of the anode-side inlet 3.2 and, to the same extent, the cross section of the cathode-side outlet 4.2. In this way, the pressure on the cathode side 4 is increased with respect to the pressure on the anode side 3. By contrast, if the pressure on the cathode side 4 is higher than the pressure on the anode side 3, the membrane expands into the region 6 and the actuator 8, 9 and/or the blocking unit 11 reduces the cross section of the cathode-side inlet 4.1 and, to the same extent, the cross section of the anode-side outlet 3.1. In this way, the pressure on the anode side 3 is increased with respect to the pressure on the cathode side 4. The way in which the actuator 8, 9 acts on the anode side 3 and on the cathode side 4 of the fuel cell unit 2 is therefore oppositely directed. If the actuator 8, 9 acts on the inlet of one side, it acts to the same extent on the outlet of the other side, and vice versa. The simultaneous action on the anode side 3 and the cathode side 4 reinforces the effect of the pressure regulator compared to single-sided application.

The pressure regulator 1 according to the invention preferably has guide lines 10 for the actuator 8, 9, which connect the anode-side region 6 of the membrane 5 to the anode-side inlet 3.2 and the anode-side outlet 3.1 and connect the cathode-side region 7 of the membrane 5 to the cathode-side inlet 4.1 and the cathode-side outlet 4.2. The guide lines 10 are used to preset the directions of movement of the actuator 8, 9 and therefore to prevent the actuator 8, 9 from jamming.

In a further configuration of the invention, the pressure regulator 1 acts only on the inlet 3.2 and the outlet 3.1 of the anode side 3 of the fuel cell unit 2. If the pressure on the anode side 3 is higher than the pressure on the cathode side 4, the membrane 5 expands into the region 7, and the actuator 8 reduces the cross section of the anode-side inlet 3.2. This leads to a fall in the pressure on the anode side 3. If the pressure on the cathode side 4 is higher than the pressure on the anode side 3, the membrane 5 expands into the region 6 and the actuator 8 reduces the cross section of the anode-side outlet 3.1. As a result, the pressure on the anode side 3 rises.

In a further configuration of the invention, the pressure regulator 1 acts only on the inlet 4.1 and the outlet 4.2 of the cathode side 4 of the fuel cell unit 2. If the pressure on the anode side 3 is higher than the pressure on the cathode side 4, the membrane 5 expands into the region 7 and the actuator 9 reduces the cross section of the cathode-side outlet 4.2. This leads to an increase in the pressure on the cathode side 4. By contrast, if the pressure on the cathode side 4 is higher than the pressure on the anode side 3, the membrane 5 expands into the region 6 and the actuator 9 reduces the cross section of the cathode-side inlet 4.1. In this way, the pressure on the cathode side 4 is reduced.

In a further configuration of the invention, the pressure regulator 1 acts only on the inlets 3.2, 4.1 of the fuel cell unit 2. If the pressure on the anode side 3 is higher than the pressure on the cathode side 4, the membrane 5 expands into the region 7, and the actuator 8 reduces the cross section of the anode-side inlet 3.2. In this way, the pressure on the anode side 3 is reduced. If the pressure on the cathode side 4 is higher than the pressure on the anode side 3, the membrane expands into the region 6 and the actuator 9 reduces the cross section of the cathode-side inlet 4.1. This leads to a reduction in the pressure on the cathode side 4.

In a further configuration of the invention, the pressure regulator 1 acts only on the outlets 3.1, 4.2 of the fuel cell unit 2. If the pressure on the anode side 3 is higher than the pressure on the cathode side 4, the membrane 5 expands into the region 7 and the actuator 9 reduces the cross section of the cathode-side outlet 4.2. This leads to a rise in the pressure on the cathode side 4. By contrast, if the pressure on the cathode side 4 is higher than the pressure on the anode side 3, the membrane 5 expands into the region 6 and the actuator 9 reduces the cross section of the anode-side outlet 3.1. This then leads to a rise in the pressure on the anode side 3.

The individual and flexible design options in this embodiment of the pressure regulator 1 provide the user with additional degrees of freedom with regard to installation and appearance of the pressure regulator 1.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A pressure regulator for a fuel cell unit including,
an anode side having an inlet for a hydrogen-rich gas and an outlet for anode exhaust gas, and
a cathode side having an inlet for an oxygen-rich gas and an outlet for cathode exhaust gas,
the pressure regulator comprising:
an anode-side region;
a cathode-side region;
a membrane separating the anode-side and cathode-side regions, wherein the membrane is configured so that the membrane is acted on in the anode-side region by pressure of the anode side and in the cathode-side region by pressure of the cathode side; and
an actuator connected to the membrane, wherein the actuator sets a predetermined pressure on at least one of the anode and cathode sides.

2. The pressure regulator according to claim 1, wherein the actuator acts on a cross section of at least one of the inlet and outlet of the anode side.

3. The pressure regulator according to claim 2, wherein the actuator acts on a cross section of at least one of the inlet and outlet of the cathode side.

4. The pressure regulator according to claim 1, wherein the actuator acts on a cross section of at least one of the inlet and outlet of the cathode side.

5. The pressure regulator according to claim 1, wherein the actuator is rigidly connected to the membrane and can be moved to and fro by membrane movement.

6. The pressure regulator according to claim 1, further comprising guide lines for the actuator, which guide lines connect the anode-side region of the membrane to the anode-side inlet and the anode-side outlet.

7. The pressure regulator according to claim 6, wherein the guide lines further connect the cathode-side region of the membrane to the cathode-side inlet and the cathode-side outlet.

8. The pressure regulator according to claim 1, further comprising guide lines for the actuator, which guide lines connect the cathode-side region of the membrane to the cathode-side inlet and the cathode-side outlet.

9. The pressure regulator according to claim 1, further comprising guide lines for the actuator, which guide lines connect the anode-side region of the membrane to the anode-side inlet and the cathode-side region to the cathode-side inlet.

10. The pressure regulator according to claim 9, wherein the guide lines further connect the anode-side region to the anode-side outlet and the cathode-side region to the cathode-side outlet.

11. The pressure regulator according to claim 1, further comprising guide lines for the actuator, which guide lines connect the anode-side region to the anode-side outlet and the cathode-side region to the cathode-side outlet.

12. The pressure regulator according to claim 1, wherein the actuator has a blocking unit which is rigidly connected to the membrane.

13. The pressure regulator according to claim 12, wherein the actuator includes a rigid stem that connects the blocking unit to the membrane.

14. A method of making a pressure regulator for a fuel cell unit including,
an anode side having an inlet for a hydrogen-rich gas and an outlet for anode exhaust gas, and
a cathode side having an inlet for an oxygen-rich gas and an outlet for cathode exhaust gas,
the method comprising:
using a membrane to separate the pressure requlator into an anode-side region and a cathode-side region so that the membrane is acted on in the anode-side region by pressure of the anode side and in the cathode-side region by pressure of the cathode side; and
connecting an actuator to the membrane, wherein the actuator sets a predetermined pressure on at least one of the anode and cathode sides.

15. The method according to claim 14, wherein the actuator acts on a cross section of at least one of the inlet and outlet of the anode side.

16. The method according to claim 15, wherein the actuator acts on a cross section of at least one of the inlet and outlet of the cathode side.

17. The method according to claim 14, wherein the actuator acts on a cross section of at least one of the inlet and outlet of the cathode side.

18. The method according to claim 14, further comprising rigidly connecting the actuator to the membrane so that the actuator can be moved to and fro by membrane movement.

19. The method according to claim 14, further comprising guiding the actuator using guide lines, which connect the anode-side region of the membrane to the anode-side inlet and the anode-side outlet.

20. The method according to claim 19, wherein the guide lines further connect the cathode-side region of the membrane to the cathode-side inlet and the cathode-side outlet.

21. The method according to claim 14, further comprising guiding the actuator using guide lines, which connect the cathode-side region of the membrane to the cathode-side inlet and the cathode-side outlet.

22. The pressure regulator according to claim 14, further comprising guiding the actuator using guide lines, which connect the anode-side region of the membrane to the anode-side inlet and the cathode-side region to the cathode-side inlet.

23. The method according to claim 22, wherein the guide lines further connect the anode-side region to the anode-side outlet and the cathode-side region to the cathode-side outlet.

24. The method according to claim 14, further comprising guiding the actuator using guide lines, which connect the anode-side region to the anode-side outlet and the cathode-side region to the cathode-side outlet.

25. The method according to claim 14, further comprising rigidly connecting a blocking unit of the actuator to the membrane.

26. The method according to claim 25, further comprising connecting the blocking unit to the membrane using a rigid stem of the actuator.
